(19) United States
(12) Patent Application Publication
(10) Pub. No.: US 2013/0342553 A1
(43) Pub. Date: Dec. 26, 2013

(54) TEXTURE MAPPING TECHNIQUES

(71) Applicant: Jacob Subag, Kiryat Haim (IL)

(72) Inventor: Jacob Subag, Kiryat Haim (IL)

(73) Assignee: INTEL CORPORATION, Santa Clara, CA (US)

(21) Appl. No.: 13/531,762

(22) Filed: Jun. 25, 2012

(51) Int. Cl. G06T 11/40

(52) U.S. Cl. 345/552

(57) ABSTRACT

Improved techniques for texture mapping are described. In one embodiment, for example, a host may include a processor circuit and a graphics management module, and the graphics management module may be operable by the processor circuit to determine that a texture value corresponding to a texture coordinate is unavailable, determine a marginal texture coordinate corresponding to the texture coordinate, determine a marginal texture value corresponding to the marginal texture coordinate, and store the marginal texture value in a memory unit. Other embodiments are described and claimed.

### BACKGROUND

In various traditional computing systems, the rendering of graphics on one or more display devices may involve jointly processing information defining shapes of graphics elements to be displayed and information defining visual characteristics of surfaces, axes, vertices, planes, or other geometric features defined by those shapes. For example, in some traditional computing systems, a particular graphics element may be rendered by jointly processing information defining the shape of that element and a texture map that defines visual characteristics, such as colors and textures, that the surfaces of the element should exhibit. This joint processing may include executing an algorithm to map texels of a texture map to corresponding points on a geometric shape or surface. Such an algorithm may include logic indicating, for a particular point on the geometric shape or surface, a location within the texture map that contains a texel to be mapped to that point.

In some cases, this logic may “point” to a location that falls outside a boundary of the texture map, and thus the algorithm may fail to identify a texel to be mapped to the particular point in question. One manner in which traditional computing systems address such contingencies is by utilizing a “wrap mode.” When wrap mode is employed, and the aforementioned algorithm points to a location that falls outside a boundary of the texture map, a texel on an opposite boundary of the texture map may be identified and mapped to the point in question. When a complex shape or texture map is processed in wrap mode, the process of identifying texels on opposite boundaries of the texture map may need to be repeated many times, which may require significant computational resources and reduce performance. Consequently, techniques for reducing the computational load associated with a wrap mode are desirable.

### BRIEF DESCRIPTION OF THE DRAWINGS

FIG. 1 illustrates one embodiment of a host and one embodiment of a first system.

FIG. 2A illustrates one embodiment of a first texture correspondence and one embodiment of a second texture correspondence.

FIG. 2B illustrates one embodiment of a third texture correspondence.

FIG. 2C illustrates one embodiment of a fourth texture correspondence.

FIG. 2D illustrates one embodiment of a fifth texture correspondence.

FIG. 3A illustrates one embodiment of a texture map.

FIG. 3B illustrates a second embodiment of a texture map.

FIG. 3C illustrates a third embodiment of a texture map.

FIG. 3D illustrates a fourth embodiment of a texture map.

FIG. 4 illustrates one embodiment of a mapping of a texture to a shape.

FIG. 5 illustrates one embodiment of a logic flow.

FIG. 6 illustrates one embodiment of a second system.

FIG. 7 illustrates one embodiment of a third system.

FIG. 8 illustrates one embodiment of a device.

### DETAILED DESCRIPTION

Various embodiments may be generally directed to improved techniques for texture mapping. In one embodiment, for example, a host may include a processor circuit and a graphics management module, and the graphics management module may be operable by the processor circuit to determine that a texture value corresponding to a texture coordinate is unavailable, determine a marginal texture coordinate corresponding to the texture coordinate, determine a marginal texture value corresponding to the marginal texture coordinate, and store the marginal texture value in a memory unit. In this manner, if a texture value corresponding to the texture coordinate is subsequently requested, the marginal texture value may simply be retrieved and returned, rather than having to be computed on the fly. As a result, the computational load on the host may be reduced. Other embodiments may be described and claimed.

Various embodiments may include one or more elements. An element may include any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment. Furthermore, aspects or elements from different embodiments may be combined.

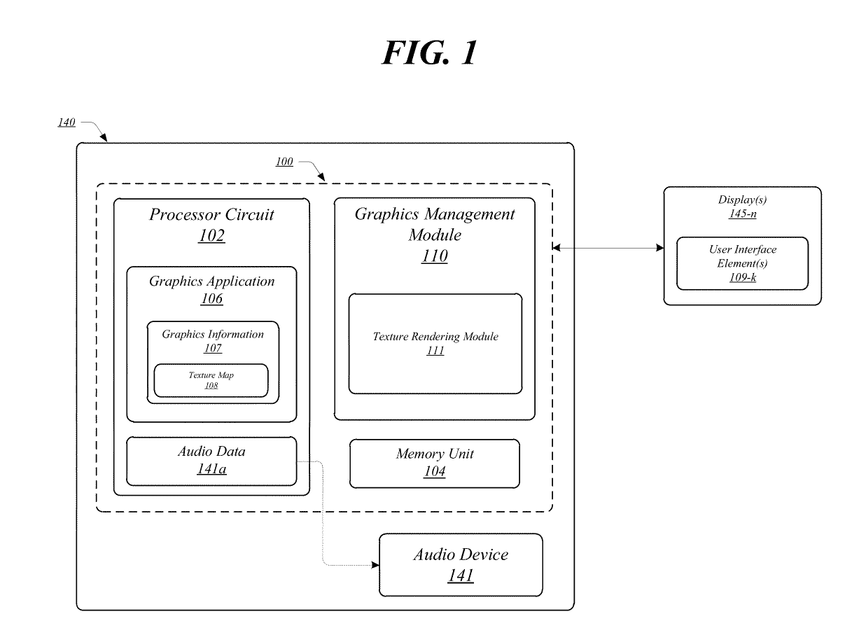

FIG. 1 illustrates a block diagram of a host 100. As shown in FIG. 1, host 100 includes multiple elements including a processor circuit 102, a memory unit 104, and a graphics management module 110. The embodiments, however, are not limited to the type, number, or arrangement of elements shown in this figure.

In various embodiments, host 100 may include processor circuit 102. Processor circuit 102 may be implemented using any processor or logic device, such as a complex instruction set computer (CISC) microprocessor, a reduced instruction set computing (RISC) microprocessor, a very long instruction word (VLIW) microprocessor, an x86 instruction set compatible processor, a processor implementing a combination of instruction sets, a multi-core processor such as a dual-core processor or dual-core mobile processor, or any other microprocessor or central processing unit (CPU). Processor circuit 102 may also be implemented as a dedicated processor, such as a controller, a microcontroller, an embedded processor, a chip multiprocessor (CMP), a co-processor, a digital signal processor (DSP), a network processor, a media processor, an input/output (I/O) processor, a media access control (MAC) processor, a radio baseband processor, an application specific integrated circuit (ASIC), a field programmable gate array (FPGA), a programmable logic device (PLD), and so forth. In one embodiment, for example, processor circuit 102 may be implemented as a general purpose processor, such as a processor made by Intel® Corporation, Santa Clara, Calif. The embodiments are not limited in this context.

In some embodiments, host 100 may include a memory unit 104 communicatively coupled to processor circuit 102. Memory unit 104 may be implemented using any machine-readable or computer-readable media capable of storing data, including both volatile and non-volatile memory. For example, memory unit 104 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory unit 104 may be included on the same integrated circuit as processor circuit 102, or alternatively some portion or all of memory unit 104 may be disposed on an integrated circuit or other medium, for example a hard disk drive, that is external to the integrated circuit of processor circuit 102. The embodiments are not limited in this context.

In various embodiments, host 100 may include graphics management module 110. Graphics management module 110 may include logic or circuitry operative to process information, logic, or data received from processor circuit 102 and/or one or more elements internal or external to host 100 and to generate graphics processing information based on the received information, logic, or data. In some embodiments, graphics management module 110 may include a graphics driver. Examples of graphics management module 110 may include but are not limited to a graphics driver microchip or card, graphics driver circuitry integrated into a multi-purpose microchip or card, and a graphics driver implemented as software. The embodiments are not limited in this context.

FIG. 1 may also illustrate a block diagram of a system 140 in various embodiments. System 140 may include any of the aforementioned elements of host 100. System 140 may further include an audio device 141 in some embodiments. Audio device 141 may include any device capable of generating tones, music, speech, speech utterances, sound effects, background noise, or other sounds based on received audio data. Examples of audio device 141 may include a speaker, a multi-speaker system, a home entertainment system, a television, a consumer appliance, a computer system, a mobile device, and a portable electronic media device, among other examples. The embodiments are not limited in this context.

In various embodiments, audio device 141 may be arranged to generate tones, music, speech, speech utterances, sound effects, background noise, or other sounds based on audio data 141a received from host 100. In some embodiments, audio data 141a may be generated by processor circuit 102 in execution of a graphics application 106. The embodiments are not limited in this context.

In various embodiments, host 100 and/or system 140 may be arranged to communicatively couple with one or more displays 145-n. It is worthy of note that “n” and similar designators as used herein are intended to be variables representing any positive integer. Thus, for example, if an implementation sets a value for n=3, then a complete set of displays 145-n may include displays 145-1, 145-2, and 145-3. Display(s) 145-n may include any device(s) capable of displaying one or more user interface elements. User interface elements may include any visual or optical sensory effect(s) such as, for example, images, pictures, video, text, graphics, menus, textures, and/or patterns. Examples for display(s) 145-n may include a television, a monitor, a projector, and a computer screen. In one embodiment, for example, display(s) 145-n may be implemented by liquid crystal display (LCD) displays, light emitting diode (LED) displays, or other types of suitable visual interfaces. Display(s) 145-n may include, for example, touch-sensitive color display screens. In various implementations, display(s) 145-n may include one or more thin-film transistors (TFT) LCD including embedded transistors. The embodiments are not limited in this context.

In some embodiments, processor circuit 102 may be operable to execute a graphics application 106. Graphics application 106 may include any application featuring graphics capabilities, such as, for example, an image or video viewing application, an image or video playback application, a streaming video playback application, a multimedia application program, a system program, a conferencing application, a gaming application, a productivity application, a messaging application, an instant messaging (IM) application, an electronic mail (email) application, a short messaging service (SMS) application, a multimedia messaging service (MMS) application, a social networking application, a web browsing application, and so forth. The embodiments are not limited in this context.

In various embodiments, graphics application 106 may be operative to generate graphics information 107. Graphics information 107 may include data, information, or logic corresponding to one or more user interface elements 109-k. The data, information, or logic included within graphics information 107 may be usable by host 100, system 140, and/or one or more elements external to host 100 and/or system 140 to cause user interface elements 109-k or one or more other images to be displayed by one or more displays 145-n. In some embodiments, graphics information 107 may include information defining shapes of graphics elements to be displayed and information defining visual characteristics of surfaces, axes, vertices, planes, or other geometric features defined by those shapes. In various such embodiments, graphics information 107 may include one or more shapes and one or more texture maps, and graphics management module 110 may process graphics information 107 to cause user interface elements 109-k to be displayed by applying the one or more texture maps to the one or more shapes. The embodiments are not limited in this context.

In some embodiments, graphics management module 110 may include a texture rendering module 111. Texture rendering module 111 may include logic, circuitry, instructions, or data operative to execute one or more mapping algorithms to map one or more points, regions, or areas of one or more texture maps to one or more points, regions, or areas of one or more shapes. In various embodiments, for example, this mapping may include applying one or more texture values of a point on a texture map to a corresponding point on a shape. The one or more texture values may include various measures of visual characteristics, and may include, for example, color, hue, brightness, intensity, contrast, saturation, and/or other visual properties. Texture rendering module 111 may conduct the mapping algorithm based on one or more texture correspondences. Each texture correspondence may identify one or more points, regions, or areas of a texture map, texture values of which are to be mapped to one or more points, regions, or areas of a shape. The embodiments are not limited in this context.

In some embodiments, points, regions, or areas of a texture map may be identified using one or more texture coordinates, and points, regions, or areas of a shape may be identified by one or more shape coordinates. In some such embodiments, each texture correspondence may define a correspondence between a texture coordinate and a shape coordinate, and indicate that texture values of a point, region, or area of the texture map defined by the texture coordinate are to be applied to a point, region, or area of the shape defined by the shape coordinate. In various embodiments, a texture map may include a plurality of texels, and each texture coordinate may identify one or more texels. In various embodiments, a texel may include a fundamental unit of texture space, such that a texture may be represented by an array of texels, such as a texture map. Within a texture map including an array of texels representing a particular texture, the characteristics associated with the various texels in the array may vary in accordance with characteristics of the texture. The embodiments are not limited in this context.

In various embodiments, some texture coordinates may constitute unavailable texture coordinates. An unavailable texture coordinate may be defined as a texture coordinate that identifies a point that lies outside the boundaries of a texture map. An unavailable texture value may be defined as a texture value that corresponds to an unavailable texture coordinate. In some embodiments, one or more texture correspondences may define correspondences between one or more shape coordinates and one or more unavailable texture coordinates. The embodiments are not limited in this context.

In general operation of host 100 and/or system 140, graphics application 106 may generate a series of portions of graphics information 107, corresponding to a series of user interface elements 109-k to be displayed on one or more displays 145-n. Some portions of graphics information 107 may include new shapes and/or new texture maps to be processed by graphics management module 110 and/or texture rendering module 111, while other portions may not. For example, some portions of graphics information 107 may include information indicating that a previously received texture map is to be applied to a previously received shape according to a different set of texture correspondences. As such, graphics management module 110 and/or one or more other components of host 100 and/or system 140 may store one or more shapes, texture maps, and/or correspondences in memory unit 104 for ongoing access. For example, when graphics management module 110 receives graphics information 107 including a texture map 108, it may store that texture map 108 in memory unit 104 for ongoing access. Additionally or alternatively, processor circuit 102 and/or graphics application 106 may be operative to store texture map 108 in memory unit 104 directly. The embodiments are not limited in this context.

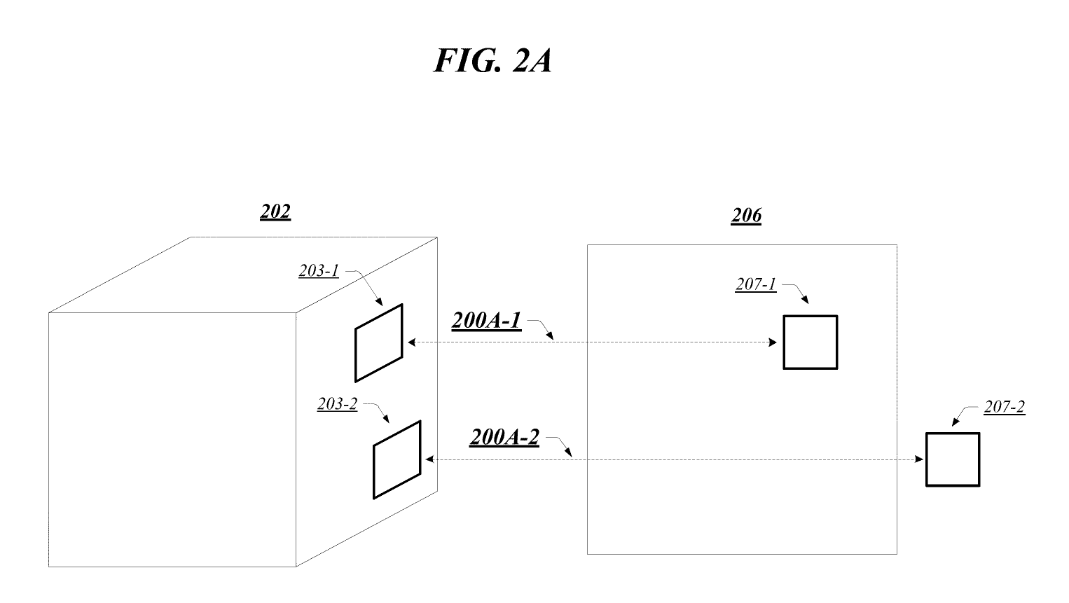

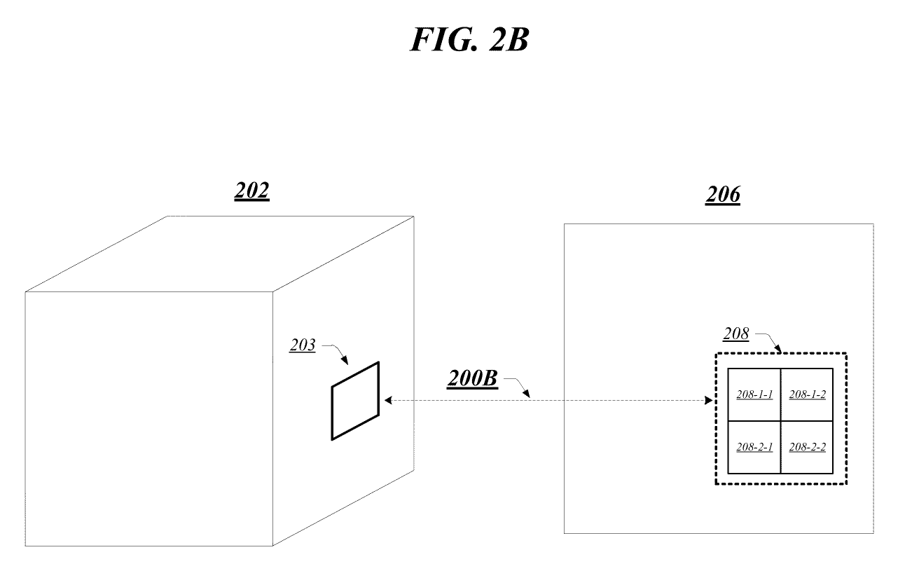

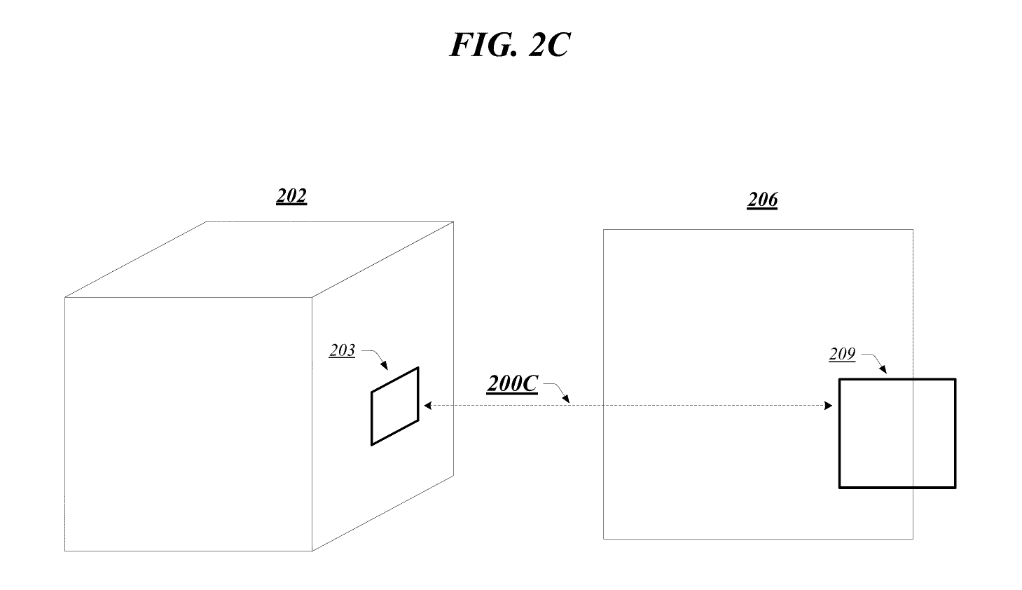

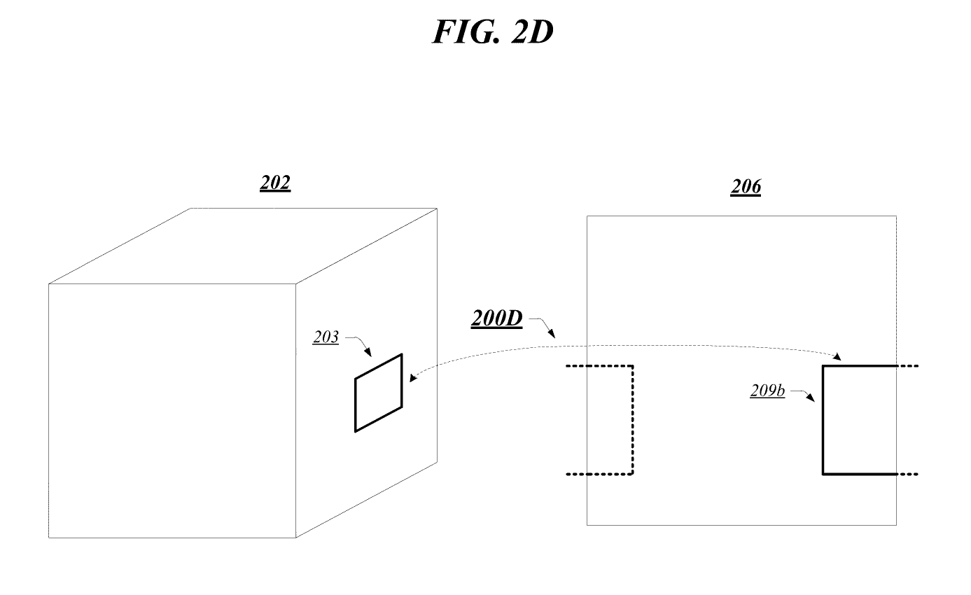

FIG. 2A illustrates one embodiments of a first texture correspondence 200A-1 and one embodiment of a first texture correspondence 200A-2. As shown in FIG. 2A, a shape 202 includes regions 203-1 and 203-2, which may be defined by one or more shape coordinates in some embodiments. Although shape 202 in FIG. 2A is illustrated as a three-dimensional rectangular solid, and regions 203-1 and 203-2 are illustrated as regions on a face of that three-dimensional rectangular solid, the embodiments are not limited in this context. Texture map 206 includes texels 207-1 and 207-2, which may be identified by one or more texture coordinates in various embodiments. Texture correspondence 200A-1 indicates that texel 207-1 in texture map 206 corresponds to region 203-1 on shape 202. Based on texture correspondence 200A-1, host 100 and/or system 140 may determine one or more texture values associated with texel 207-1 and map the one or more texture values to region 203-1 on shape 202. Although texture map 206 is illustrated as a two-dimensional texture map for ease of understanding, other texture map configurations are both possible and contemplated. For example, in some embodiments, texture map 206 may include a three-dimensional texture map. The embodiments are not limited in this context.

Region 207-2 in FIG. 2A may constitute an example of a region identified by an unavailable texture coordinate. As shown in FIG. 2A, region 207-2 lies outside the boundaries of texture map 206. As such, a texture coordinate identifying region 207-2 may constitute an unavailable texture coordinate, and a texture value corresponding to such a texture coordinate may constitute an unavailable texture value. Texture 200A-2 indicates that region 207-2 corresponds to region 203-2 on shape 202. Based on texture correspondence 200A-2, host 100 and/or system 140 may determine that a texture value to be mapped to region 203-2 on shape 202 is an unavailable texture value. The embodiments are not limited to this example.

FIG. 2B illustrates one embodiment of a third texture correspondence 200B. As shown in FIG. 2B, texture correspondence 200B indicates that a region 208 in texture map 206 corresponds to region 203 on shape 202. In the example of FIG. 2B, region 208 includes a group of texels 208-1-1, 208-1-2, 208-2-1, and 208-2-2. Based on texture correspondence 200B, texture rendering module 111 may determine one or more texture values associated with texels 208-1-1, 208-1-2, 208-2-1, and 208-2-2, and map these texture values to region 203 on shape 202. In various embodiments, mapping one or more texture values associated with a group of texels such as that of region 208 to region 203 on shape 202 may include determining one or more composite texture values based on one or more individual texture values associated with each of the texels in region 208. For example, graphics management module 110 may be operative to determine individual brightness values for each texel in region 208, determine a composite brightness value based on the individual brightness values, and map the composite brightness value to region 203 on shape 202. In some embodiments, graphics management module 110 may determine composite texture values using a weighted or un-weighted average of individual texture values of texels in a group. In various embodiments, graphics management module 110 may determine composite texture values and/or weights to be used in calculating composite texture values based on information contained in graphics information 107. The embodiments are not limited in this context.

FIG. 2C illustrates one embodiment of a fourth texture correspondence 200C. Texture correspondence 200C includes an example of a texture correspondence which maps unavailable texels of a texture map to a shape. As shown in FIG. 2C, region 209 is mapped to region 203 on shape 202. However, while region 209 includes portions of texture map 206, it also includes points which lie outside texture map 206. In some embodiments, graphics management module 110 may process texture correspondences such as texture correspondence 200C by implementing a wrap mode. In such a wrap mode, portions of region 209 which extend beyond a boundary of texture map 206 may be supplemented or filled with regions of texture map 206 appearing on a different and/or opposite boundary. The embodiments are not limited in this context.

FIG. 2D illustrates one embodiment of a fifth texture correspondence 200D. Texture correspondence 200D includes an example of a texture correspondence according to a wrap mode. As shown in FIG. 2D, region 209b extends beyond a boundary of texture map 206, and is supplemented with regions of texture map 206 appearing on an opposite boundary thereof. The embodiments are not limited to this example.

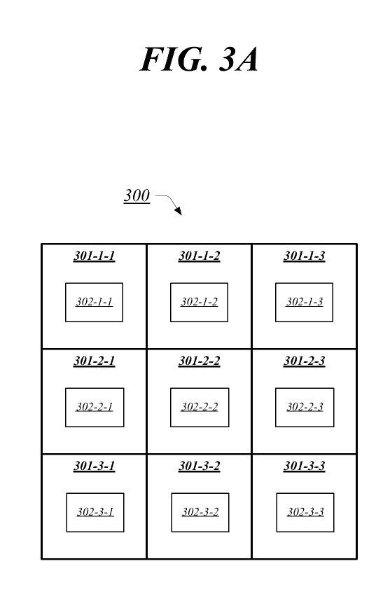

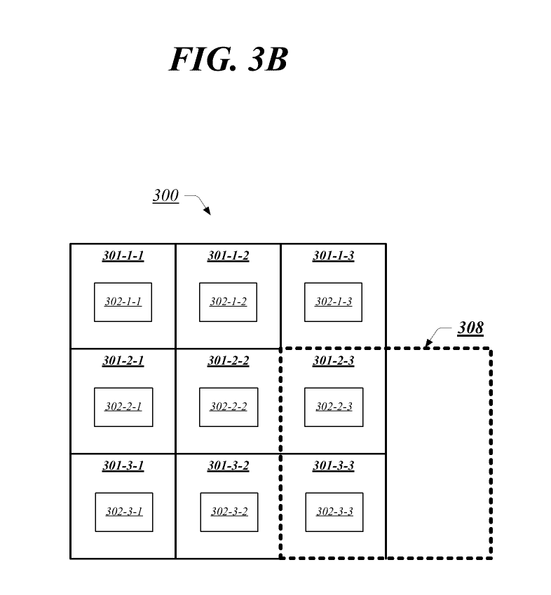

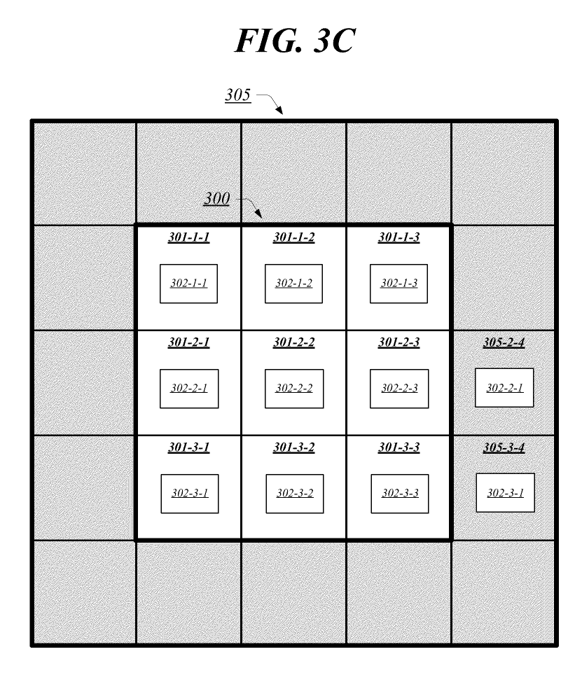

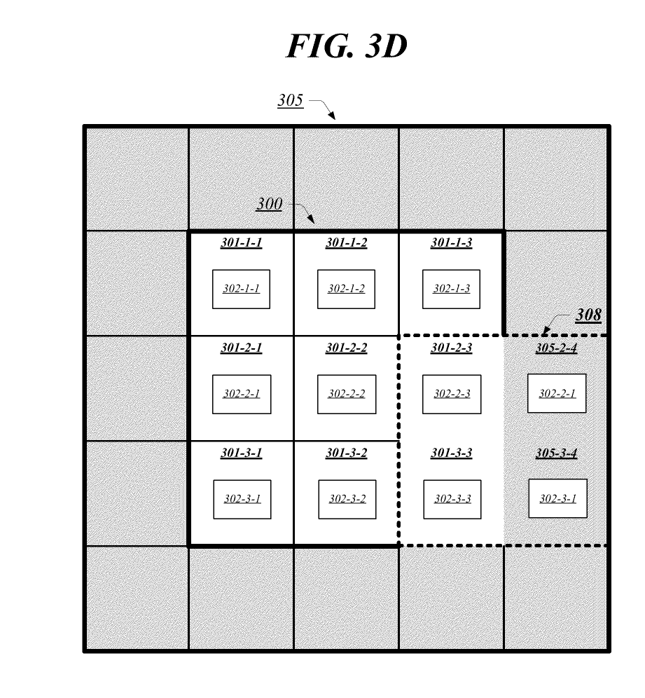

FIG. 3A illustrates one embodiment of a texture map 300. As shown in FIG. 3A, texture map 300 includes a plurality of texels 301-r-s. Associated with each texel 301-r-s are corresponding texture values 302-r-s. The embodiments are not limited in this context.

FIG. 3B illustrates a second embodiment of texture map 300. As shown in FIG. 3B, a region 308 is overlayed upon texture map 300. Region 308 overlaps texels 301-2-3 and 301-3-3 as well as an area outside a boundary of texture map 300. As such, region 308 includes a region that extends beyond a boundary of texture map 300.

FIG. 3C illustrates a third embodiment of texture map 300, in which a wrap mode is implemented. As shown in FIG. 3C, texture map 300 has been supplemented with marginal texels 305-t-v. Marginal texels 305-t-v may include notional texels representing adjacency of particular actual texels within texture map 300 in wrap mode. In other words, rather than including actual texels within texture map 300, marginal texels 305-t-v may include logical constructs used to facilitate application of wrap mode to texture map 300. In various embodiments, texture values associated with the particular actual texels the adjacency of which marginal texels 305-t-v are used to represent may be assigned to marginal texels 305-t-v and stored as precomputed texture values for marginal texels 305-t-v. Each of marginal texels 305-t-v may lie outside a boundary of texture map 300, and correspond to a texel appearing on a different and/or opposite boundary of texture map 300. In the example of FIG. 3C, marginal texels 305-2-4 and 305-3-4 may correspond to texels 301-2-1 and 301-3-1 respectively. Accordingly, the texture values 302-2-1 and 302-3-1 associated with marginal texels 305-2-4 and 305-3-4 respectively may be the same as those associated with texels 301-2-1 and 301-3-1 respectively. The embodiments are not limited in this context.

FIG. 3D illustrates a fourth embodiment of texture map 300, in which a wrap mode is implemented. As shown in FIG. 3D, region 308 includes texels 301-2-3 and 301-3-3, and marginal texels 305-2-4 and 305-3-4. In an example embodiment, graphics management module 110 may be operative to compute composite texture values for region 308 based on individual texture values 302-2-3, 302-3-3, 302-2-1, and 302-3-1 associated with texels 301-2-3 and 301-3-3 and marginal texels 305-2-4 and 305-3-4, respectively. The embodiments are not limited in this context.

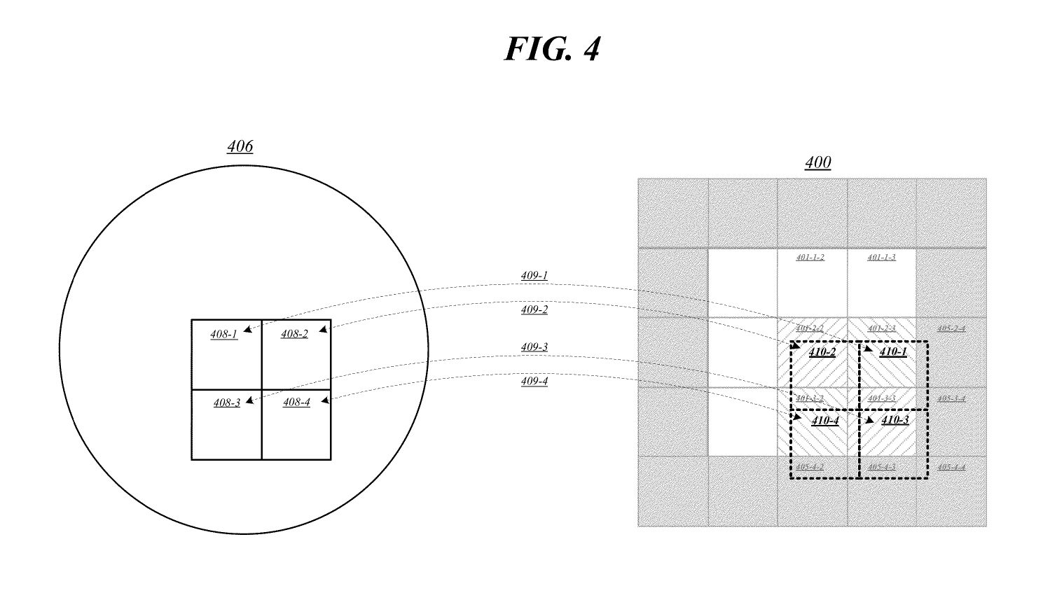

FIG. 4 illustrates an one embodiment of a mapping of a texture to a shape. As shown in FIG. 4, a texture map 400 includes texels 401-2-2, 401-2-3, 401-3-2, and 401-3-3. Also shown are marginal texels 405-2-4, 405-3-4, 405-4-2, 405-4-3, and 405-4-4. A shape 406 includes regions 408-1, 408-2, 408-3, and 408-4. Based on texture correspondences 409-1, 409-2, 409-3, and 409-4, respectively, regions 410-1, 410-2, 410-3, and 410-4 in texture map 400 are mapped to regions 408-1, 408-2, 408-3, and 408-4 in shape 406, respectively.

Each of regions 410-1, 410-2, 410-3, and 410-4 overlaps more than one texel and/or marginal texel of texture map 400. Therefore, in various embodiments, mapping texture map 400 to shape 406 may include computing composite texture values for regions 410-1, 410-2, 410-3, and 410-4 based on individual texture values for multiple texels and/or marginal texels of texture map 400. For example, region 408-2 of shape 406 corresponds to region 410-2 of texture map 400, based on texture correspondence 409-2. Region 410-2 of texture map 400 overlaps texels 401-2-2, 401-2-3, 401-3-2, and 401-3-3. As such, in some embodiments, mapping region 410-2 of texture map 400 to region 408-2 in shape 406 may include computing a composite texture value based on individual texture values for texels 401-2-2, 401-2-3, 401-3-2, and 401-3-3, and assigning the composite texture value to region 408-2 in shape 406. In various embodiments, the composite texture value may include a weighted average of the individual texture values, wherein each individual texture value is weighted in proportion to the extent of the overlap between region 410-2 and the texel to which the individual texture value corresponds. The embodiments are not limited in this context.

Regions 410-1, 410-3, and 410-4 of texture map 400 extend beyond the bottom and/or right boundaries of texture map 400, and thus may be said to overlap marginal texels corresponding to those boundaries. For example, region 410-4 of texture map 400 extends beyond the bottom boundary of texture map 400, and may be said to overlap marginal texels 405-4-2 and 405-4-3. In various embodiments, mapping regions of texture map 400 that overlap marginal texels to regions in shape 406 may include computing composite texture values based in part on individual texture values associated with the marginal texels. The individual texture values associated with the marginal texels may be determined based on individual texture values associated with texels appearing on an opposite boundary of the texture map. For example, texels 401-1-2 and 401-1-3 appear on an opposite boundary of the texture map from marginal texels 405-4-2 405-4-3, respectively. Thus, individual texture values associated with texels 401-1-2 and 401-1-3 may be assigned to marginal texels 405-4-2 and 405-4-3, respectively. As such, computing a composite texture value for region 410-4 of texture map 400, for example, may include computing a composite texture value based on individual texture values for texels 401-3-2, 401-3-3, 401-1-2, and 401-1-3. The embodiments are not limited in this context.

As noted above, in general operation, graphics management module 110 and/or one or more other components of host 100 and/or system 140 may be operative to store texture maps in memory unit 104 for ongoing access. In various embodiments, in order to facilitate operation in a wrap mode, graphics management module 110 may be operative to define and store one or more marginal texels 305-t-v for a texture map 300, and store the marginal texels 305-t-v, the texture values corresponding thereto, and one or more texture correspondences in memory unit 104. By precomputing marginal texels 305-t-v and the texture values corresponding thereto, and storing this information in memory unit 104, graphics management module may reduce the need to identify texture values corresponding to marginal texels on the fly, and thus reduce the processing load associated with operation in a wrap mode. In some embodiments, graphics management module 110 may receive graphics information 107 including changes to a texture map 300, and modify the texture map 300 in memory unit 104. Subsequently, graphics management module 110 may determine that texture map 300 has changed, determine one or more updated marginal texture values based on the changes to texture map 300, and store the updated marginal texture values in memory unit 104. The embodiments are not limited in this context.

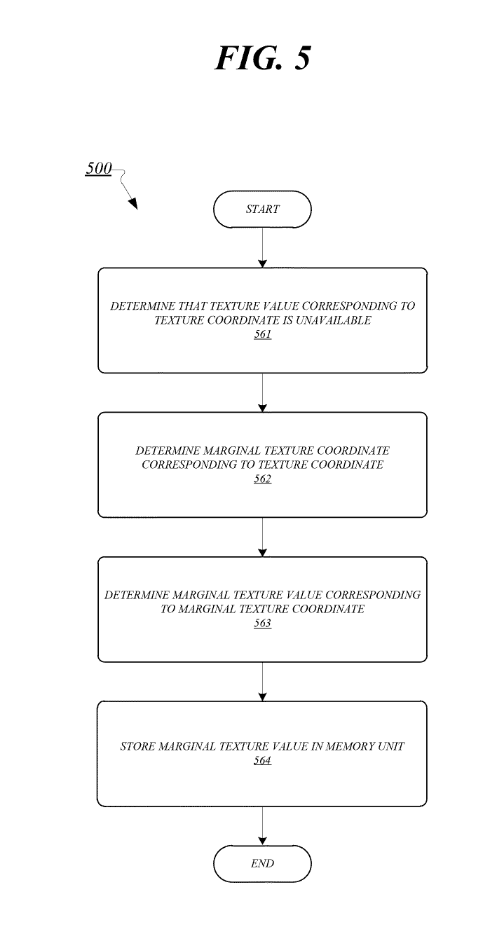

FIG. 5 illustrates one embodiment of a logic flow 500, which may be representative of the operations executed by one or more embodiments described herein. Particularly, logic flow 500 may be representative of operations associated with precomputing and storing marginal texture values for a texture map. As shown in logic flow 500, it may be determined at 561 that a texture value corresponding to a texture coordinate is unavailable. For example, graphics management module 110 of FIG. 1 may determine that a texture value corresponding to a texture coordinate is unavailable. At 562, a marginal texture coordinate corresponding to the texture coordinate may be determined. For example, graphics management module 110 of FIG. 1 may determine a marginal texture coordinate corresponding to the texture coordinate. At 563, a marginal texture value corresponding to the marginal texture coordinate may be determined. For example, graphics management module 110 of FIG. 1 may determine a marginal texture value corresponding to the marginal texture coordinate. At 564, the marginal texture value may be stored in a memory unit. For example, graphics management module 110 of FIG. 1 may store the marginal texture value in memory unit 104. The embodiments are not limited to these examples.

In various embodiments, once marginal texture values have been stored in memory unit 104, graphics management module 110 may be operative to receive a request for a texture value corresponding to a texture coordinate that is unavailable. In some such embodiments, graphics management module 110 may be operative to determine that the texture value is unavailable and return a marginal texture value associated with the texture coordinate. In some embodiments, graphics management module 110 may be operative to determine that a texture value is unavailable and return a marginal texture value using a single control path. The embodiments are not limited in this context.

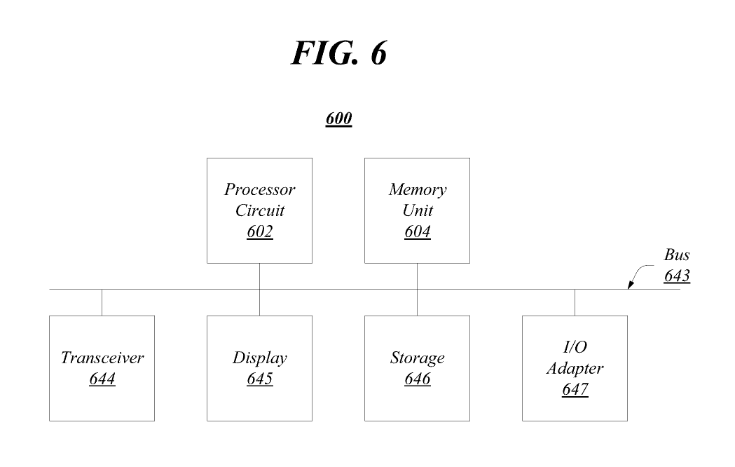

FIG. 6 illustrates one embodiment of a system 600. In various embodiments, system 600 may be representative of a system or architecture suitable for use with one or more embodiments described herein, such as host 100 and/or system 140 of FIG. 1 and/or logic flow 500 of FIG. 5. The embodiments are not limited in this respect.

As shown in FIG. 6, system 600 may include multiple elements. One or more elements may be implemented using one or more circuits, components, registers, processors, software subroutines, modules, or any combination thereof, as desired for a given set of design or performance constraints. Although FIG. 6 shows a limited number of elements in a certain topology by way of example, it can be appreciated that more or less elements in any suitable topology may be used in system 600 as desired for a given implementation. The embodiments are not limited in this context.

In various embodiments, system 600 may include a processor circuit 602. Processor circuit 602 may be implemented using any processor or logic device, and may be the same as or similar to processor circuit 102 of FIG. 1.

In one embodiment, system 600 may include a memory unit 604 to couple to processor circuit 602. Memory unit 604 may be coupled to processor circuit 602 via communications bus 643, or by a dedicated communications bus between processor circuit 602 and memory unit 604, as desired for a given implementation. Memory unit 604 may be implemented using any machine-readable or computer-readable media capable of storing data, including both volatile and non-volatile memory, and may be the same as or similar to memory unit 104 of FIG. 1. In some embodiments, the machine-readable or computer-readable medium may include a non-transitory medium. The embodiments are not limited in this context.

In various embodiments, system 600 may include a transceiver 644. Transceiver 644 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, transceiver 644 may operate in accordance with one or more applicable standards in any version. The embodiments are not limited in this context.

In various embodiments, system 600 may include a display 645. Display 645 may include any television type monitor or display. Display 645 may include any display device capable of displaying information received from processor circuit 602, and may be the same as or similar to displays 145-n of FIG. 1. The embodiments are not limited in this context.

In various embodiments, system 600 may include storage 646. Storage 646 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 646 may include technology to increase the storage performance enhanced protection for valuable digital media when multiple hard drives are included, for example. Further examples of storage 646 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, system 600 may include one or more I/O adapters 647. Examples of I/O adapters 647 may include Universal Serial Bus (USB) ports/adapters, IEEE 1394 Firewire ports/adapters, and so forth. The embodiments are not limited in this context.

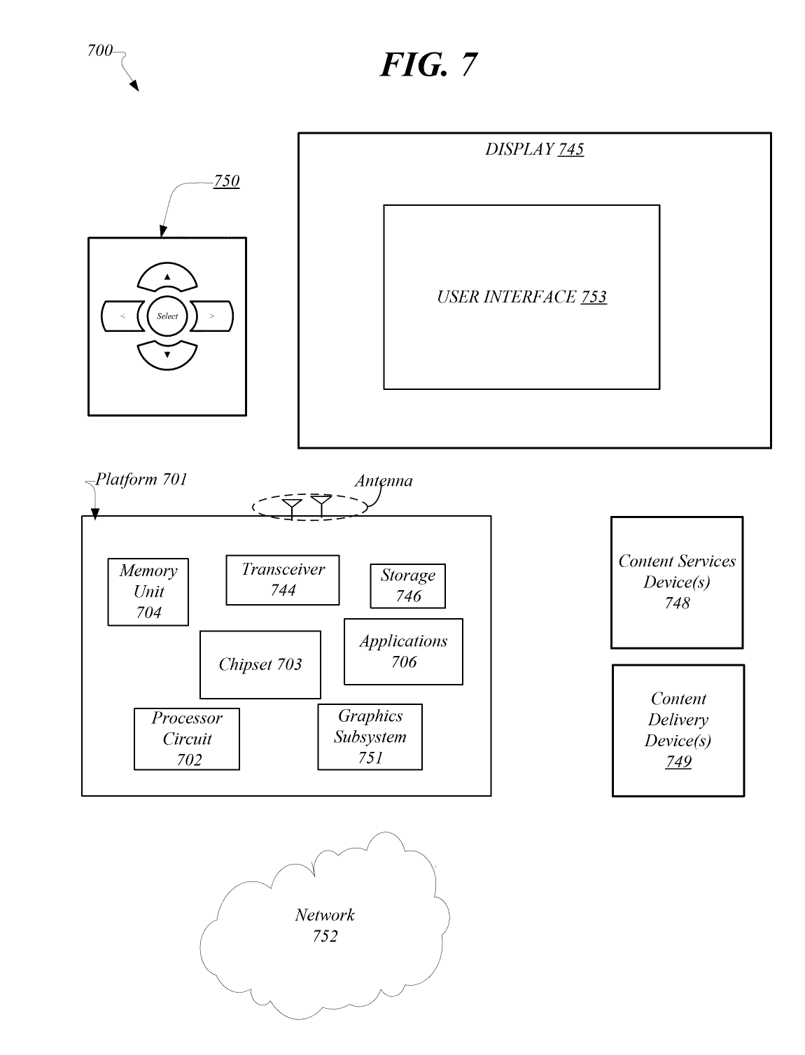

FIG. 7 illustrates an embodiment of a system 700. In various embodiments, system 700 may be representative of a system or architecture suitable for use with one or more embodiments described herein, such as host 100 and/or system 140 of FIG. 1, logic flow 500 of FIG. 5, and/or system 600 of FIG. 6. The embodiments are not limited in this respect.

As shown in FIG. 7, system 700 may include multiple elements. One or more elements may be implemented using one or more circuits, components, registers, processors, software subroutines, modules, or any combination thereof, as desired for a given set of design or performance constraints. Although FIG. 7 shows a limited number of elements in a certain topology by way of example, it can be appreciated that more or less elements in any suitable topology may be used in system 700 as desired for a given implementation. The embodiments are not limited in this context.

In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 includes a platform 701 coupled to a display 745. Platform 701 may receive content from a content device such as content services device(s) 748 or content delivery device(s) 749 or other similar content sources. A navigation controller 750 including one or more navigation features may be used to interact with, for example, platform 701 and/or display 745. Each of these components is described in more detail below.

In embodiments, platform 701 may include any combination of a processor circuit 702, chipset 703, memory unit 704, transceiver 744, storage 746, applications 751, and/or graphics subsystem 752. Chipset 703 may provide intercommunication among processor circuit 702, memory unit 704, transceiver 744, storage 746, applications 751, and/or graphics subsystem 752. For example, chipset 703 may include a storage adapter (not depicted) capable of providing intercommunication with storage 746.

Processor circuit 702 may be implemented using any processor or logic device, and may be the same as or similar to processor circuit 602 in FIG. 6.

Memory unit 704 may be implemented using any machine-readable or computer-readable media capable of storing data, and may be the same as or similar to memory unit 604 in FIG. 6.

Transceiver 744 may include one or more radios capable of transmitting and receiving signals using various suitable wireless communications techniques, and may be the same as or similar to transceiver 644 in FIG. 6.

Display 745 may include any television type monitor or display, and may be the same as or similar to display 645 in FIG. 6.

Storage 746 may be implemented as a non-volatile storage device, and may be the same as or similar to storage 646 in FIG. 6.

Graphics subsystem 752 may perform processing of images such as still or video for display. Graphics subsystem 752 may be a graphics processing unit (GPU) or a visual processing unit (VPU), for example. An analog or digital interface may be used to communicatively couple graphics subsystem 752 and display 745. For example, the interface may be any of a High-Definition Multimedia Interface, DisplayPort, wireless HDMI, and/or wireless HD compliant techniques. Graphics subsystem 752 could be integrated into processor circuit 702 or chipset 703. Graphics subsystem 752 could be a stand-alone card communicatively coupled to chipset 703.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

In embodiments, content services device(s) 748 may be hosted by any national, international and/or independent service and thus accessible to platform 701 via the Internet, for example. Content services device(s) 748 may be coupled to platform 701 and/or to display 745. Platform 701 and/or content services device(s) 748 may be coupled to a network 753 to communicate (e.g., send and/or receive) media information to and from network 753. Content delivery device(s) 749 also may be coupled to platform 701 and/or to display 745.

In embodiments, content services device(s) 748 may include a cable television box, personal computer, network, telephone, Internet enabled devices or appliance capable of delivering digital information and/or content, and any other similar device capable of unidirectionally or bidirectionally communicating content between content providers and platform 701 and/display 745, via network 753 or directly. It will be appreciated that the content may be communicated unidirectionally and/or bidirectionally to and from any one of the components in system 700 and a content provider via network 753. Examples of content may include any media information including, for example, video, music, medical and gaming information, and so forth.

Content services device(s) 748 receives content such as cable television programming including media information, digital information, and/or other content. Examples of content providers may include any cable or satellite television or radio or Internet content providers. The provided examples are not meant to limit embodiments of the invention.

In embodiments, platform 701 may receive control signals from navigation controller 750 having one or more navigation features. The navigation features of navigation controller 750 may be used to interact with a user interface 754, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of navigation controller 750 may be echoed on a display (e.g., display 745) by movements of a pointer, cursor, focus ring, or other visual indicators displayed on the display. For example, under the control of software applications 751, the navigation features located on navigation controller 750 may be mapped to virtual navigation features displayed on user interface 754. In embodiments, navigation controller 750 may not be a separate component but integrated into platform 701 and/or display 745. Embodiments, however, are not limited to the elements or in the context shown or described herein.

In embodiments, drivers (not shown) may include technology to enable users to instantly turn on and off platform 701 like a television with the touch of a button after initial boot-up, when enabled, for example. Program logic may allow platform 701 to stream content to media adaptors or other content services device(s) 748 or content delivery device(s) 749 when the platform is turned “off.” In addition, chip set 703 may include hardware and/or software support for 5.1 surround sound audio and/or high definition 7.1 surround sound audio, for example. Drivers may include a graphics driver for integrated graphics platforms. In embodiments, the graphics driver may include a peripheral component interconnect (PCI) Express graphics card.

In various embodiments, any one or more of the components shown in system 700 may be integrated. For example, platform 701 and content services device(s) 748 may be integrated, or platform 701 and content delivery device(s) 749 may be integrated, or platform 701, content services device(s) 748, and content delivery device(s) 749 may be integrated, for example. In various embodiments, platform 701 and display 745 may be an integrated unit. Display 745 and content service device(s) 748 may be integrated, or display 745 and content delivery device(s) 749 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as I/O adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 701 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 7.

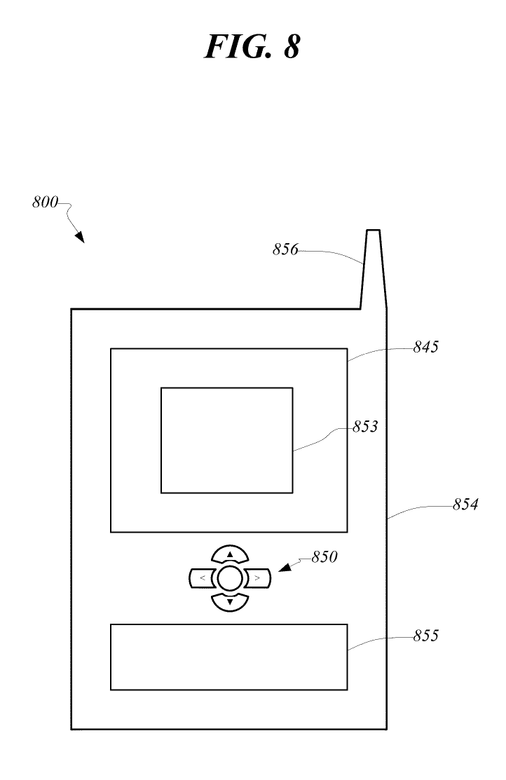

As described above, system 700 may be embodied in varying physical styles or form factors. FIG. 8 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 8, device 800 may include a display 845, a navigation controller 850, a user interface 854, a housing 855, an I/O device 856, and an antenna 857. Display 845 may include any suitable display unit for displaying information appropriate for a mobile computing device, and may be the same as or similar to display 745 in FIG. 7. Navigation controller 850 may include one or more navigation features which may be used to interact with user interface 854, and may be the same as or similar to navigation controller 750 in FIG. 7. I/O device 856 may include any suitable I/O device for entering information into a mobile computing device. Examples for I/O device 856 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments:

A method may comprise determining, by a processor circuit, that a texture value corresponding to a texture coordinate is unavailable, determining a marginal texture coordinate corresponding to the texture coordinate, determining a marginal texture value corresponding to the marginal texture coordinate, and storing the marginal texture value in a memory unit.

Such a method may comprise receiving a request for a texture value corresponding to the unavailable texture coordinate, determining that the texture value is unavailable, and providing the stored marginal texture value.

According to such a method, the texture coordinate may comprise a location in a texture map comprising a plurality of texels.

Such a method may comprise determining marginal texture coordinates for each texel that is located on a boundary of the texel map, determining marginal texture values for each of the determined marginal texture coordinates, and storing the determined marginal texture values in the memory unit.

Such a method may comprise determining that the texture map has changed, determining an updated marginal texture value, and storing the updated marginal texture value.

Such a method may comprise determining that the texture value is unavailable and returning the marginal texture value using a single control path.

According to such a method, the texture map may comprise a three-dimensional texture map.

An apparatus may comprise a processor circuit and a graphics management module operative on the processor circuit to determine that a texture value corresponding to a texture coordinate of a texture map is unavailable, and store a marginal texture value for the unavailable texture coordinate in a memory unit.

In such an apparatus, the graphics management module may be operative to receive a request for a texture value corresponding to the unavailable texture coordinate, determine that the texture value is unavailable, and provide the stored marginal texture value.

In such an apparatus, the texture coordinate may comprise a location in the texture map, and the texture map may comprise a plurality of texels.

In such an apparatus, the graphics management module may be operative to determine marginal texture coordinates for each texel that is located on a boundary of the texel map, determine marginal texture values for each of the determined marginal texture coordinates, and store the determined marginal texture values in the memory unit.

In such an apparatus, the graphics management module may be operative to determine that the texture map has changed, determine an updated marginal texture value, and store the updated marginal texture value.

In such an apparatus, the graphics management module may be operative to determine that the texture value is unavailable and return the marginal texture value using a single control path.

In such an apparatus, the texture map may comprise a three-dimensional texture map.

A system may comprise a processor circuit, an audio device communicatively coupled to the processor circuit, and a graphics management module operative on the processor circuit to determine that a texture value corresponding to a texture coordinate comprising a location in a texture map comprising a plurality of texels is unavailable, determine a marginal texture coordinate corresponding to the texture coordinate, determine a marginal texture value corresponding to the marginal texture coordinate, and store the marginal texture value in a memory unit.

In such a system, the graphics management module may be operative to receive a request for the texture value corresponding to the unavailable texture coordinate, determine that the texture value is unavailable, and provide the stored marginal texture value.

In such a system, the graphics management module may be operative to determine marginal texture coordinates for each texel that is located on a boundary of the texel map, determine marginal texture values for each of the determined marginal texture coordinates, and store the determined marginal texture values in the memory unit.

In such a system, the graphics management module may be operative to determine that the texture map has changed, determine an updated marginal texture value, and store the updated marginal texture value.

In such a system, the graphics management module may be operative to determine that the texture value is unavailable and return the marginal texture value using a single control path.

In such a system, the texture map may comprise a three-dimensional texture map.

At least one machine-readable medium may comprise a plurality of instructions that, in response to being executed on a computing device, cause the computing device to determine that a texture value corresponding to a texture coordinate is unavailable, determine a marginal texture value corresponding to the texture value, and store the marginal texture value in a memory unit.

Such at least one machine-readable medium may comprise instructions that, in response to being executed on the computing device, cause the computing device to receive a request for a texture value corresponding to the unavailable texture coordinate, determine that the texture value is unavailable, and provide the stored marginal texture value.

In such at least one machine-readable medium, the texture coordinate may comprise a location in a texture map comprising a plurality of texels, and the at least one machine-readable medium may comprise instructions that, in response to being executed on the computing device, cause the computing device to determine marginal texture coordinates for each texel that is located on a boundary of the texel map, determine marginal texture values for each of the determined marginal texture coordinates, and store the determined marginal texture values in the memory unit.

Such at least one machine-readable medium may comprise instructions that, in response to being executed on the computing device, cause the computing device to determine that the texture map has changed, determine an updated marginal texture value, and store the updated marginal texture value.

Such at least one machine-readable medium may comprise instructions that, in response to being executed on the computing device, cause the computing device to determine that the texture value is unavailable and return the marginal texture value using a single control path.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
determining, by a processor circuit, that a texture value corresponding to a texture coordinate is unavailable;
determining a marginal texture coordinate corresponding to the texture coordinate;
determining a marginal texture value corresponding to the marginal texture coordinate; and
storing the marginal texture value in a memory unit.

2. The computer-implemented method of claim 1, comprising:
receiving a request for a texture value corresponding to the unavailable texture coordinate;
determining that the texture value is unavailable; and
providing the stored marginal texture value.

3. The computer-implemented method of claim 1, the texture coordinate comprising a location in a texture map comprising a plurality of texels.

4. The computer-implemented method of claim 3, comprising:
determining marginal texture coordinates for each texel that is located on a boundary of the texel map;
determining marginal texture values for each of the determined marginal texture coordinates; and
storing the determined marginal texture values in the memory unit.

5. The computer-implemented method of claim 3, comprising:
determining that the texture map has changed;
determining an updated marginal texture value; and
storing the updated marginal texture value.

6. The computer-implemented method of claim 2, comprising determining that the texture value is unavailable and returning the marginal texture value using a single control path.

7. The computer-implemented method of claim 3, the texture map comprising a three-dimensional texture map.

8. An apparatus, comprising:
a processor circuit; and
a graphics management module operative on the processor circuit to determine that a texture value corresponding to a texture coordinate of a texture map is unavailable and store a marginal texture value for the unavailable texture coordinate in a memory unit.

9. The apparatus of claim 8, the graphics management module operative to:
receive a request for a texture value corresponding to the unavailable texture coordinate;
determine that the texture value is unavailable; and
provide the stored marginal texture value.

10. The apparatus of claim 8, the texture coordinate comprising a location in the texture map, the texture map comprising a plurality of texels.

11. The apparatus of claim 10, the graphics management module operative to:
determine marginal texture coordinates for each texel that is located on a boundary of the texel map;
determine marginal texture values for each of the determined marginal texture coordinates; and
store the determined marginal texture values in the memory unit.

12. The apparatus of claim 10, the graphics management module operative to:
determine that the texture map has changed;
determine an updated marginal texture value; and
store the updated marginal texture value.

13. The apparatus of claim 9, the graphics management module operative to determine that the texture value is unavailable and return the marginal texture value using a single control path.

14. The apparatus of claim 10, the texture map comprising a three-dimensional texture map.

15. A system, comprising:
a processor circuit;
an audio device communicatively coupled to the processor circuit; and
a graphics management module operative on the processor circuit to determine that a texture value corresponding to a texture coordinate comprising a location in a texture map comprising a plurality of texels is unavailable, determine a marginal texture coordinate corresponding to the texture coordinate, determine a marginal texture value corresponding to the marginal texture coordinate, and store the marginal texture value in a memory unit.

16. The system of claim 15, the graphics management module operative to:
receive a request for the texture value corresponding to the unavailable texture coordinate;
determine that the texture value is unavailable; and
provide the stored marginal texture value.

17. The system of claim 16, the graphics management module operative to:
determine marginal texture coordinates for each texel that is located on a boundary of the texel map;
determine marginal texture values for each of the determined marginal texture coordinates; and
store the determined marginal texture values in the memory unit.

18. The system of claim 16, the graphics management module operative to:
determine that the texture map has changed;
determine an updated marginal texture value; and
store the updated marginal texture value.

19. The system of claim 16, the graphics management module operative to determine that the texture value is unavailable and return the marginal texture value using a single control path.

20. The system of claim 16, the texture map comprising a three-dimensional texture map.

21. At least one machine-readable medium comprising a plurality of instructions that, in response to being executed on a computing device, cause the computing device to:
determine that a texture value corresponding to a texture coordinate is unavailable;
determine a marginal texture value corresponding to the texture value; and
store the marginal texture value in a memory unit.

22. The at least one machine-readable medium of claim 21, comprising instructions that, in response to being executed on the computing device, cause the computing device to:
receive a request for a texture value corresponding to the unavailable texture coordinate;
determine that the texture value is unavailable; and
provide the stored marginal texture value.

23. The at least one machine-readable medium of claim 21, the texture coordinate comprising a location in a texture map comprising a plurality of texels, the at least one machine-readable medium comprising instructions that, in response to being executed on the computing device, cause the computing device to:
determine marginal texture coordinates for each texel that is located on a boundary of the texel map;
determine marginal texture values for each of the determined marginal texture coordinates; and
store the determined marginal texture values in the memory unit.

24. The at least one machine-readable medium of claim 21, comprising instructions that, in response to being executed on the computing device, cause the computing device to:
determine that the texture map has changed;
determine an updated marginal texture value; and
store the updated marginal texture value.

25. The at least one machine-readable medium of claim 21, comprising instructions that, in response to being executed on the computing device, cause the computing device to determine that the texture value is unavailable and return the marginal texture value using a single control path.
